(19) United States
(12) Patent Application Publication
(10) Pub. No.: US 2026/0204861 A1
(43) Pub. Date: Jul. 16, 2026

(54) MULTICORE FIBER, OPTICAL COUPLER, AND OPTICAL AMPLIFIER

(71) Applicant: LIGHTERA JAPAN CO., LTD., Tokyo (JP)

(72) Inventors: Koichi MAEDA, Tokyo (JP); Shigehiro TAKASAKA, Tokyo (JP); Ryuichi SUGIZAKI, Tokyo (JP); Masanori TAKAHASHI, Tokyo (JP)

(73) Assignee: LIGHTERA JAPAN CO., LTD., Tokyo (JP)

(21) Appl. No.: 19/548,161

(22) Filed: Feb. 24, 2026

Related U.S. Application Data
(63) Continuation of application No. PCT/JP2024/031921, filed on Sep. 5, 2024.

(30) Foreign Application Priority Data
Sep. 7, 2023 (JP) 2023-144958

(51) Int. Cl. H01S 3/067

(52) U.S. Cl. CPC H01S 3/06737

(57) ABSTRACT

A multicore fiber includes: a plurality of core portions each being made of glass; an inner cladding portion made of glass with a lower refractive index than maximum refractive indices of the core portions and surrounding outer peripheries of the plurality of core portions; and an outer cladding portion made of glass with a lower refractive index than the refractive index of the inner cladding portion and surrounding the inner cladding portion.

This application is a continuation of International Application No. PCT/JP2024/031921, filed on Sep. 5, 2024 which claims the benefit of priority of the prior Japanese Patent Application No. 2023-144958, filed on Sep. 7, 2023, the entire contents of which are incorporated herein by reference.

### BACKGROUND

The present disclosure is related to a multicore fiber, an optical coupler, and an optical amplifier.

It is expected that, with use of a multicore Erbium-Doped optical Fiber Amplifier (EDFA) as an optical amplifier for use in submarine optical communication or the like, power consumption of the optical amplifier is reduced, for example.

There is a known configuration in which a double-clad multicore EDF is used as a multicore EDFA to optically excite erbium that is an optical amplifying medium included in a core portion by a cladding pumping method is known (see Kazi S Abedin et al, “Multimode Erbium Doped Fiber Amplifiers for Space Division Multiplexing Systems”, JOURNAL OF LIGHTWAVE TECHNOLOGY, VOL. 32, NO. 16, Aug. 15, 2014 pp. 2800-2808 and Kazi S Abedin et al, “Cladding-pumped erbium-doped multicore fiber amplifier”, OPTICS EXPRESS Vol. 20, No. 18, 27 Aug. 2012 pp. 20191-20200).

In the multicore EDFA, when the optical amplifying medium included in the core portion is to be excited, in some cases, an optical fiber called a side-coupled type or a transverse-coupled type may be used, for example (Japanese Laid-open Patent Publication No. 2021-163814). In the side-coupled optical coupler, for example, a pumping light optical fiber for transmitting pumping light is welded onto an inner cladding portion of a multicore fiber and comes into contact with a contact region. As a result, at least a part of the pumping light that propagates through the pumping light optical fiber is coupled with the inner cladding portion of the multicore fiber from the contact region.

### SUMMARY

When heat is applied to the multicore fiber when an optical fiber, such as a pumping light optical fiber, is to be welded onto the multicore fiber, in some cases, the multicore fiber may be affected by the heat. For example, in some cases, a dopant that is doped with the core portion to increase a refractive index may diffuse due to the heat. In this case, the refractive index of the core portion is reduced, so that inter-core crosstalk between a plurality of core portions may be increased. Furthermore, the core portion may be deformed by the heat, which may increase inter-core crosstalk.

There is a need for a multicore fiber that is able to reduce an influence of heat when an optical fiber is to be welded onto the multicore fiber, and an optical coupler and an optical amplifier using the multicore fiber.

According to one aspect of the present disclosure, there is provided a multicore fiber including: a plurality of core portions each being made of glass; an inner cladding portion made of glass with a lower refractive index than maximum refractive indices of the core portions and surrounding outer peripheries of the plurality of core portions; and an outer cladding portion made of glass with a lower refractive index than the refractive index of the inner cladding portion and surrounding the inner cladding portion.

### BRIEF DESCRIPTION OF THE DRAWINGS

FIG. 1 is a schematic cross-sectional view of a multicore fiber according to a first embodiment;

FIG. 2 is a schematic diagram illustrating a refractive index profile of the multicore fiber illustrated in FIG. 1;

FIG. 3 is a schematic configuration diagram of an optical coupler according to a second embodiment;

FIG. 4 is a schematic cross-sectional view of a multicore fiber according to a third embodiment;

FIG. 5 is a schematic configuration diagram of an optical amplifier according to a fourth embodiment;

FIG. 6 is a schematic cross-sectional view of a multicore EDF illustrated in FIG. 5;

FIG. 7 is a schematic configuration diagram of an optical amplifier according to a first modification of the fourth embodiment; and

FIG. 8 is a schematic configuration diagram of an optical amplifier according to a second modification of the fourth embodiment.

### DETAILED DESCRIPTION

Embodiments will be described below with reference to the drawings. The present disclosure is not limited by the embodiments below. Further, in description of the drawings, the same or corresponding components are appropriately denoted by the same reference symbols, and repeated explanation will be omitted appropriately. Furthermore, it is necessary to note that the drawings are schematic, and dimensional relations among the components, ratios among the components, and the like may be different from the actual ones. Moreover, the drawings may include portions that have different dimensional relations or ratios. Furthermore, in the present specification, a cutoff wavelength or an effective cutoff wavelength indicates a cable cutoff wavelength that is defined by ITU-T G.650.1 of the International Telecommunication Union. Moreover, other terms that are not specifically defined in the present specification conform to the definitions and the measurement methods in G.650.1 and G.650.2.

In the following, a multicore fiber according to a first embodiment will be first described, and thereafter, an optical coupler that includes the multicore fiber according to the first embodiment will be described.

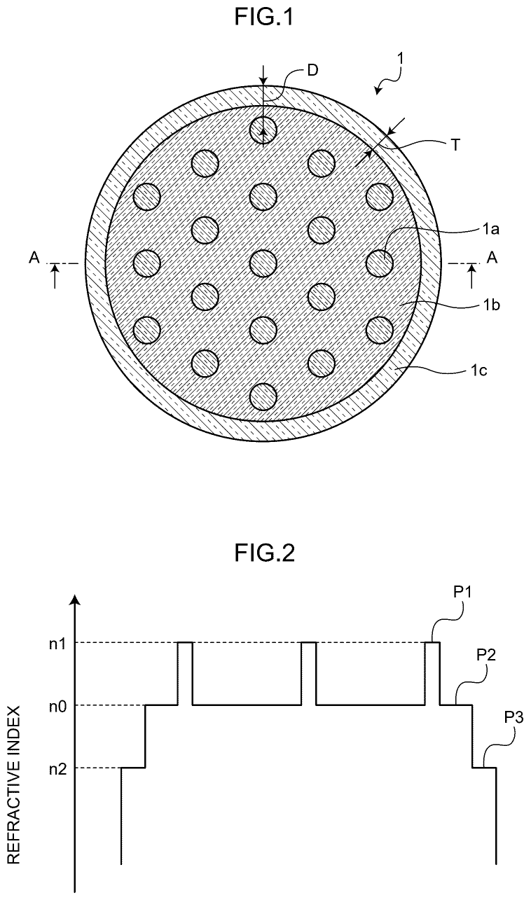

FIG. 1 is a schematic cross-sectional view of a multicore fiber according to the first embodiment, and is a cross-sectional view taken along a plane perpendicular to a longitudinal direction of a multicore fiber 1.

The multicore fiber 1 includes 19 core portions 1a, an inner cladding portion 1b, and an outer cladding portion 1c. The 19 core portions 1a are examples of a plurality of core portions.

The 19 core portions 1a have circular cross sections. The 19 core portions 1a are made of glass, such as silica-based glass, and arranged in a triangular lattice manner on a cross section of the multicore fiber 1. The inner cladding portion 1b has a circular cross section. The inner cladding portion 1b is made of glass, such as silica-based glass, and surrounds outer peripheries of the 19 core portions 1a. The outer cladding portion 1c has a circular cross section. The outer cladding portion 1c is made of glass, such as silica-based glass, and surrounds an outer periphery of the inner cladding portion 1b.

FIG. 2 is a schematic view illustrating a refractive index profile of the multicore fiber 1, and illustrates a refractive index profile on a cross section taken along a line A-A in FIG. 1. In FIG. 2, a profile P1 indicates a refractive index profile of each of the core portions 1a, a profile P2 indicates a refractive index profile of the inner cladding portion 1b, and a profile P3 indicates a refractive index profile of the outer cladding portion 1c. As illustrated in FIG. 2, a refractive index n0 of the inner cladding portion 1b is lower than a maximum refractive index n1 of each of the core portions 1a. Further, a refractive index n2 of the outer cladding portion 1c is lower than the refractive index n0 of the inner cladding portion 1b. Furthermore, the refractive indices of the inner cladding portion 1b and the outer cladding portion 1c are approximately constant independently of positions in a radial direction.

For example, the core portions 1a are made of fused quartz doped with germanium, the inner cladding portion 1b is made of pure fused quartz, and the outer cladding portion 1c is made of fused quartz doped with fluorine. With this configuration, the refractive index profile as illustrated in FIG. 2 is realized. Meanwhile, pure fused quartz is fused quartz with extremely high purity, which does not substantially contain dopant that changes a refractive index and which has a refractive index of about 1.444 at a wavelength of 1550 nanometers (nm).

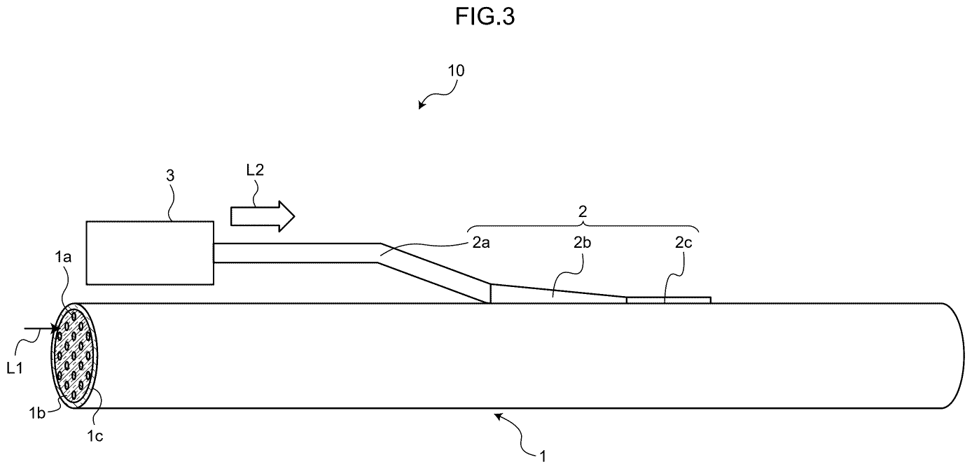

FIG. 3 is a schematic configuration diagram of an optical coupler according to a second embodiment. An optical coupler 10 includes the multicore fiber 1 illustrated in FIG. 1 and an optical coupling optical fiber 2.

The optical coupling optical fiber 2 includes a constant diameter portion 2a, a tapered portion 2b, and a small diameter portion 2c that are arranged in this order in a longitudinal direction. The optical coupling optical fiber 2 serves as a multimode optical fiber in the constant diameter portion 2a. The multimode optical fiber is a step-index type in which a core diameter and a clad diameter are set to, for example, 105 micrometers (μm) and 125 μm, respectively, and a numerical aperture (NA) is set to, for example, equal to or larger than 0.16 and equal to or smaller than 0.28. Meanwhile, the NA may be set to equal to or smaller than 0.22.

The tapered portion 2b and the small diameter portion 2c are arranged along the outer cladding portion 1c of the multicore fiber 1, and welded onto an outer peripheral surface of the outer cladding portion 1c. The tapered portion 2b is a portion in which an outer diameter is reduced in a tapered manner from an outer diameter of the constant diameter portion 2a in the longitudinal direction. The small diameter portion 2c is a portion which is extended in the longitudinal direction and in which an outer diameter is approximately the same as the reduced outer diameter of the tapered portion 2b. The optical coupling optical fiber 2 that is configured as described above may be fabricated by forming the tapered portion 2b and the small diameter portion 2c by, for example, processing a distal end portion of the multimode optical fiber by thermal deformation or the like. The tapered portion 2b and the small diameter portion 2c are welded onto the outer cladding portion 1c by heating using a burner, for example. The tapered portion 2b and the small diameter portion 2c are one example of a portion of the optical coupling optical fiber in the longitudinal direction.

The optical coupling optical fiber 2 is an optical fiber that transmits light that is to be coupled with the inner cladding portion 1b of the multicore fiber 1. Specifically, in the present embodiment, a pumping light source 3 inputs pumping light L2 to the optical coupling optical fiber 2. Here, the pumping light source 3 is, for example, a transverse multimode semiconductor laser and outputs the pumping light L2. The optical coupling optical fiber 2 transmits the pumping light L2 in a multimode. The pumping light L2 is leaked from the optical coupling optical fiber 2 at the tapered portion 2b and the small diameter portion 2c, and coupled with the inner cladding portion 1b through the outer cladding portion 1c. The pumping light L2 that is coupled with the inner cladding portion 1b propagates through the inner cladding portion 1b. The pumping light L2 is one example of light that is input to the inner cladding portion and that propagates through the inner cladding portion.

Furthermore, signal light L1 is input to the core portion 1a of the multicore fiber 1. The core portion 1a transmits the signal light. Meanwhile, FIG. 3 illustrates a state in which the signal light L1 is input to the single core portion 1a, but the signal light may be input to each of the two or more core portions 1a. The signal light L1 is one example of light that is input to the core portion and propagates through the core portion. Meanwhile, a cutoff wavelength of each of the core portions 1a of the multicore fiber 1 is set such that the signal light L1 propagates in a single mode.

In the following, in the present specification, it is assumed that the cutoff wavelength of each the core portions of the optical fiber to which signal light is input is set such that input light, such as signal light, propagates in the single mode.

As described above, the optical coupler 10 has a function to multiplex the signal light L1 and the pumping light L2 and is configured as a side-coupled optical coupler. Meanwhile, it is preferable to set coupling efficiency of the pumping light L2 with respect to the inner cladding portion 1b to equal to or larger than 60%.

Here, as described above, the tapered portion 2b and the small diameter portion 2c of the optical coupling optical fiber 2 are welded onto the outer peripheral surface of the multicore fiber 1. When the welding as described is to be performed, and if the multicore fiber 1 does not include the outer cladding portion 1c, the tapered portion 2b and the small diameter portion 2c of the optical coupling optical fiber 2 are welded onto an outer peripheral surface of the inner cladding portion 1b. In this case, a distance between the outer peripheral surface of the inner cladding portion 1b and each of the core portions 1a is relatively short, and therefore, the core portions 1a are likely to be affected by heat that is applied at the time of welding. In particular, the core portion 1a that is located closer to the outer peripheral surface of the inner cladding portion 1b is more likely to be affected by the heat.

To reduce the influence of the heat, if an outer diameter of the inner cladding portion 1b is increased to increase the distance between the outer peripheral surface of the inner cladding portion 1b and each of the core portions 1a, a cross-sectional area of the inner cladding portion 1b is increased. As a result, optical density of the pumping light L2 in the inner cladding portion 1b is reduced.

In contrast, in the multicore fiber 1, the tapered portion 2b and the small diameter portion 2c of the optical coupling optical fiber 2 are welded onto the outer peripheral surface of the outer cladding portion 1c. As a result, the outer cladding portion 1c functions to increase a distance between the outer peripheral surface to which heat is applied at the time of welding and each of the core portions 1a, and heat capacity of the entire multicore fiber 1 is increased as compared to a case in which only the inner cladding portion 1b is provided, so that it is possible to reduce an influence of the heat on the core portions 1a. Further, the refractive index n2 of the outer cladding portion 1c is lower than the refractive index n0 of the inner cladding portion 1b, and therefore, when the pumping light L2 propagates through the multicore fiber 1, the pumping light L2 does not broaden to the outer cladding portion 1c, but propagates while being mainly confined in the inner cladding portion 1b. As a result, it is possible to prevent reduction of the optical density of the pumping light L2.

As described above, in the multicore fiber 1 according to the first embodiment and the optical coupler 10 using the multicore fiber 1, it is possible to reduce the influence of heat at the time of welding the optical coupling optical fiber 2 onto the multicore fiber 1, and it is possible to prevent reduction of the optical density of the pumping light L2 in the multicore fiber 1.

Meanwhile, in the multicore fiber 1, it is preferable to set inter-core crosstalk between the adjacent core portions 1a among the 19 core portions 1a to equal to or smaller than −50 decibel (dB) per kilometer at a wavelength of the signal light L1. With this configuration, the multicore fiber 1 provides good crosstalk characteristics for the signal light L1 that propagates through each of the core portions 1a. Meanwhile, the wavelength of the signal light L1 is not specifically limited as long as the wavelength is a wavelength of signal light used for optical fiber communication, and is, for example, a wavelength of 1550 nm bandwidth. When the wavelength of the signal light L1 is in the 1550 nm bandwidth, and, if the refractive index profile of each of the core portions 1a is a step index type, if a relative refractive-index difference of each of the core portions 1a with respect to the inner cladding portion 1b is equal to or larger than 0.35% and equal to or smaller than 2%, if a mode field diameter at the wavelength of the signal light L1 is equal to or larger than 5 μm and equal to or smaller than 11 μm, and if a center distance between the adjacent core portions 1a is equal to or larger than 27 μm (or more preferably, equal to or larger than 29 μm), inter-core cross talk of the multicore fiber 1 is equal to or smaller than −50 dB per kilometer.

Furthermore, even in the optical coupler 10, it is preferable to set inter-core cross talk between the adjacent core portions 1a among the 19 core portions 1a in the multicore fiber 1 to equal to or smaller than −50 dB per kilometer at the wavelength of the signal light L1. In the optical coupler 10, the influence of heat at the time of welding is reduced, so that it is possible to realize the good crosstalk characteristics as described above. Meanwhile, a length of the multicore fiber 1 in the optical coupler 10 is, for example, a few meters to a few tens of meters, and therefore, it is preferable to set structural parameters (a refractive index profile, a relative refractive-index difference, a core diameter, a center distance, and the like) of the multicore fiber 1 such that the inter-core crosstalk becomes equal to or smaller than −50 dB while taking into account the length and the influence of heat.

Moreover, in the multicore fiber 1, it is preferable to set a thickness T of the outer cladding portion 1c to equal to or larger than 10 μm. With this configuration, it is possible to more preferably reduce the influence of heat at the time of welding. Specifically, for example, it is possible to ensure an appropriate processing condition for a burner so as to prevent a defect, such as diffusion of additives, due to sudden application of heat to the core portions 1a. Furthermore, it is preferable to set the thickness T to equal to or smaller than 50 μm. With this configuration, it is possible to prevent an excessive increase in the outer diameter of the multicore fiber 1 and reduction of reliability of mechanical strength.

Moreover, it is preferable that a softening point of the outer cladding portion 1c is lower than a softening point of the inner cladding portion 1b. With this configuration, it is possible to reduce a needed amount of heat at the time of welding the optical coupling optical fiber 2 onto the outer peripheral surface of the outer cladding portion 1c, so that it is possible to further reduce the influence of heat at the time of welding.

Furthermore, it is preferable to set a distance D between a central axis of the core portion 1a that is located closest to the outer peripheral surface of the outer cladding portion 1c among the core portions 1a and the outer peripheral surface to equal to or larger than 20 μm. With this configuration, it is possible to reduce an amount of leakage loss from the core portions 1a to an amount that does not cause any practical problems, and the distance D that is set as described above is preferable to set the inter-core cross talk to equal to or smaller than −50 dB per kilometer. Moreover, it is preferable to set the distance D to, for example, equal to or smaller than 60 μm.

Furthermore, at the wavelength of the pumping light L2, it is preferable to set a numerical aperture (=√(n0²−n2²)) that is determined by the refractive index n0 of the inner cladding portion 1b and the refractive index n2 of the outer cladding portion 1c to equal to or larger than 0.16 and equal to or smaller than 0.28. When the numerical aperture is equal to or larger than 0.16 and equal to or smaller than 0.28 (or equal to or smaller than 0.22), it is possible to achieve adequate optical confinement of the pumping light L2 with respect to the inner cladding portion 1b. Meanwhile, when the numerical aperture is converted to a relative refractive-index difference of the outer cladding portion with respect to the inner cladding portion 1b (=(n2²−n0²)/(2n0²)), the relative refractive-index difference is equal to or larger than −1.87% and equal to or smaller than −0.7%. Moreover, in this case, it is preferable to set the thickness T of the outer cladding portion 1c to 10 times or more of the wavelength of the pumping light L2, from the viewpoint of optical confinement of the pumping light L2 with respect to the inner cladding portion 1b. For example, when the wavelength of the pumping light L2 is 980 nm, it is preferable to set the thickness T to equal to or larger than 9.8 μm. Furthermore, when the wavelength of the pumping light L2 is 1480 nm, it is preferable to set the thickness T to equal to or larger than 14.8 μm.

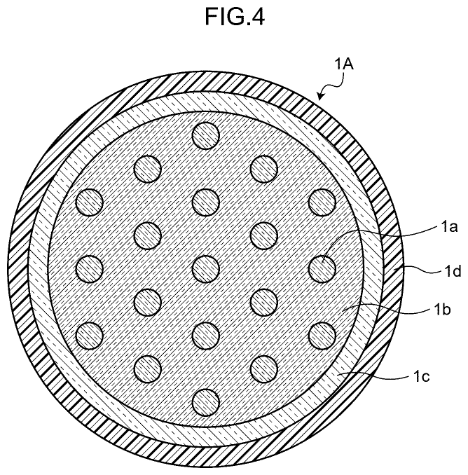

FIG. 4 is a schematic cross-sectional view of a multicore fiber according to a third embodiment. A multicore fiber 1A includes a covering layer 1d in addition to the components of the multicore fiber 1 as illustrated in FIG. 1. The covering layer 1d has a circular cross section, is made of resin with a lower refractive index than a refractive index of the outer cladding portion 1c, and surrounds the outer cladding portion 1c. The resin that constitutes the covering layer 1d is not specifically limited as long as the resin is well-known resin that covers an optical fiber, and, may be, for example, ultraviolet curable resin or thermosetting resin.

In the multicore fiber 1A that is configured as described above, it is possible to protect the outer cladding portion 1c by the covering layer 1d. Meanwhile, when the optical coupler as illustrated in FIG. 3 is configured by using the multicore fiber 1A, the covering layer 1d in a portion onto which the optical coupling optical fiber 2 is to be welded in the multicore fiber 1A is removed, and the optical coupling optical fiber 2 is welded on the exposed portion of the outer peripheral surface of the outer cladding portion 1c.

Meanwhile, as a modification of the multicore fiber according to the third embodiment, the covering layer 1d of the multicore fiber 1A may be replaced with a covering layer that has a circular cross section, that is made of resin with a refractive index equal to or larger than the refractive index of the outer cladding portion 1c, and that surrounds the outer cladding portion 1c. The resin that constitutes the covering layer as described above is not specifically limited as long as the resin is well-known resin that covers an optical fiber. Furthermore, in this case, it is preferable to set the numerical aperture that is determined by the refractive index n0 of the inner cladding portion 1b and the refractive index n2 of the outer cladding portion 1c to equal to or larger than 0.16 and equal to or smaller than 0.28 (or equal to or smaller than 0.22) at the wavelength of the pumping light L2 from the viewpoint of optical confinement of the pumping light L2 with respect to the inner cladding portion 1b. In other words, it is preferable to set a relative refractive-index difference corresponding to the numerical aperture to equal to or larger than-1.87% and equal to or smaller than −0.7%. Moreover, it is preferable to set the thickness T of the outer cladding portion 1c to 10 times or more of the wavelength of the pumping light L2.

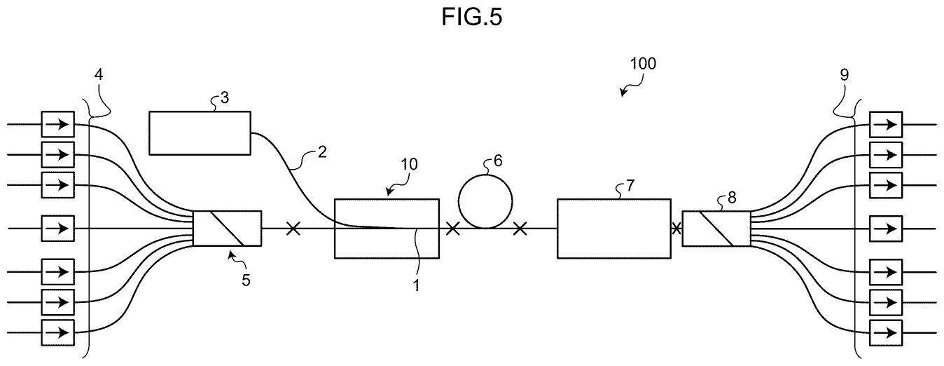

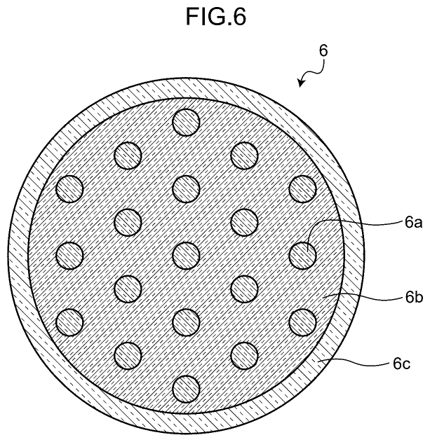

FIG. 5 is a schematic configuration diagram of an optical amplifier according to a fourth embodiment. An optical amplifier 100 includes the optical coupler 10 according to the second embodiment including the multicore fiber 1 and the optical coupling optical fiber 2, the pumping light source 3, 19 optical isolators 4, an optical fiber fan-in 5, a multicore EDF 6, a pump stripper 7, an optical fiber fan-out 8, and 19 optical isolators 9. Meanwhile, symbols “x” in the drawings indicate fusion splice points of the optical fiber.

The optical fiber fan-in 5 includes 19 single-mode optical fibers whose one ends are bundled, and a single multicore fiber that includes 19 core portions. Each of the core portions at the side at which the 19 single-mode optical fibers are bundled is optically coupled with each of the core portions of the multicore fiber. In the multicore fiber, the core portions are arranged in a triangular lattice manner similarly to the core portions 1a of the multicore fiber 1 as illustrated in FIG. 1. Further, the 19 single-mode optical fibers are, for example, standard single-mode optical fibers that are defined in ITU-T G.650.2 (International Telecommunication Union), and include the optical isolators 4, respectively. The optical isolators 4 and 9 transmit light in directions indicated by arrows, and block transmission of light in opposite directions. Each of the core portions of the multicore fiber in the optical fiber fan-in 5 is connected to each of the core portions 1a of the multicore fiber 1 of the optical coupler 10. Meanwhile, in the optical fiber fan-in, facets of the 19 single-mode optical fibers on the bundled side and a facet of the multicore fiber at which optical coupling is performed are diagonally cut with respect to an optical axis to prevent reflection, but may be orthogonal to the optical axis.

When signal light is input to each of the single-mode optical fibers of the optical fiber fan-in 5, each of the optical isolators 4 transmits each beam of the signal light. Each of the core portions of the multicore fiber transmits each beam of the signal light, and outputs the signal light to the connected core portion 1a in the multicore fiber 1. The core portion 1a transmits the input signal light.

The pumping light source 3 is, for example, a transverse multimode semiconductor laser and outputs pumping light as described above. A wavelength of the pumping light is 975 nm that is approximately the same as a wavelength of absorption peak in a wavelength bandwidth of 900 nm (for example, a first wavelength bandwidth that is equal to or larger than 970 nm and equal to or smaller than 990 nm) of erbium ion. Therefore, the pumping light is able to excite the erbium ion. The optical coupling optical fiber 2 transmits the pumping light that is output from the pumping light source. As described above, the pumping light is optically coupled with the inner cladding portion 1b of the multicore fiber 1 in the optical coupler 10, and propagates through the inner cladding portion 1b.

FIG. 6 is a schematic cross-sectional view of the multicore EDF illustrated in FIG. 5. The multicore EDF 6 includes 19 optical amplifying core portions 6a, an inner cladding portion 6b, and an outer cladding portion 6c. the 19 optical amplifying core portions 6a are one example of a plurality of optical amplifying core portions. The inner cladding portion 6b is one example of an optical amplifying inner cladding portion.

The 19 optical amplifying core portions 6a have circular cross sections. The 19 optical amplifying core portions 6a are made of glass, such as silica-based glass, that is doped with erbium ion as an optical amplifying medium, and are arranged in a triangular lattice manner similarly to the core portions 1a of the multicore fiber 1 as illustrated in FIG. 1. The inner cladding portion 6b has a circular cross section. The inner cladding portion 6b is made of glass, such as silica-based glass, and surrounds outer peripheries of the 19 optical amplifying core portions 6a. The outer cladding portion 6c has a circular cross section. The outer cladding portion 6c is made of glass, such as silica-based glass, or resin, and surrounds an outer periphery of the inner cladding portion 6b.

Further, a refractive index of the inner cladding portion 6b is lower than maximum refractive indices of the optical amplifying core portions 6a. Furthermore, a refractive index of the outer cladding portion 6c is lower than the refractive index of the inner cladding portion 6b.

The multicore EDF 6 has a well-known cladding-pumped structure, and is one example of an optical amplifying multicore fiber.

Each of the optical amplifying core portions 6a of the multicore EDF 6 is optically connected with each of the core portions 1a of the multicore fiber 1 of the optical coupler 10. Further, the inner cladding portion 6b of the multicore EDF 6 is optically connected to the inner cladding portion 1b of the multicore fiber 1. Therefore, each of the signal light and the pumping light that have propagated through the multicore EDF, when entering the multicore EDF 6, propagates through each of the optical amplifying core portions 6a and the inner cladding portion 6b in the same direction. The pumping light optically excites erbium in each of the optical amplifying core portions 6a while propagating through the inner cladding portion 6b. Each beam of the signal light that propagates through each of the optical amplifying core portions 6a is optically amplified due to the effect of simulated emission of erbium. The multicore EDF 6 outputs the optically-amplified signal light and pumping light (residual pumping light) that has not contributed to optical amplification.

The pump stripper 7 is a well-known device that transmits each beam of the signal light output from the multicore EDF 6 and eliminates the residual pumping light. The pump stripper 7 is configured such that, for example, a portion of an outer cladding of a double-clad multicore fiber including 19 core portions that are arranged in a triangular lattice manner is removed, residual pumping light is extracted from a surface of the removed portion of the inner cladding portion and applied to a heat sink or the like, causes the heat sink to absorb the light to convert energy of the residual pumping light to thermal energy, and dissipates heat. The pump stripper 7 transmits each beam of the signal light by the multicore fiber, and reduce the residual pumping light to a certain degree of power that does not cause any problems when the light is output from the optical amplifier 100.

The optical fiber fan-out 8 includes, similarly to the optical fiber fan-in 5, 19 single-mode optical fibers whose one ends are bundled, and a single multicore fiber that includes 19 core portions that are arranged in a triangular lattice manner, where each of the core portions at the side at which the 19 single-mode optical fibers are bundled is optically coupled with each of the core portions of the multicore fiber. Each of the single-mode optical fibers includes each of the optical isolators 9. The multicore fiber is connected to the pump stripper 7. Meanwhile, facets of the 19 single-mode optical fibers on the bundled side and a facet of the multicore fiber at which optical coupling is performed are diagonally cut with respect to an optical axis to prevent reflection, but may be orthogonal to the optical axis.

When signal light is input to each of the core portions of the optical fiber fan-out 8 from each of the core portions of the multicore fiber of the pump stripper 7, each beam of the signal light propagates through each of the core portions of each of the single-mode optical fibers and is output through each of the optical isolators 9.

The optical amplifier 100 that is configured as described above uses the optical coupler 10 in which an influence of heat at the time of welding the optical coupling optical fiber 2 onto the multicore fiber 1 is reduced, so that it is possible to realize good crosstalk characteristics, for example. Furthermore, the optical amplifier 100 uses the optical coupler 10 in which reduction of optical density of the pumping light is prevented, so that it is possible to prevent reduction of a gain and energy efficiency.

Meanwhile, in the embodiments as described above, the multicore fiber, such as the multicore fiber 1 and the multicore EDF 6, includes the 19 core portions, but the number of the core portions is not specifically limited. Further, the core portions need not always be arranged in a triangular lattice manner. Furthermore, in the embodiments as described above, the optical amplifying medium in the optical amplifying fiber is erbium, but it may be possible to adopt a different optical amplifying medium, such as ytterbium. Meanwhile, the wavelength of the pumping light is appropriately set to a wavelength at which the optical amplifying medium is optically excited. Moreover, in the embodiments as described above, the single pumping light source is provided and the single optical coupling optical fiber is provided in the optical coupler, but it may be possible to provide a plurality of pumping light sources and a plurality of optical coupling optical fibers in the optical coupler. Furthermore, in the embodiments as described above, the optical amplifier is a forward-pumping type, but it may be possible to adopt a backward-pumping type or a bidirectional pumping type. To configure an optical amplifier of the backward-pumping type, for example, it may be possible to connect the optical coupler 10 at the side of the optical fiber fan-out 8 and connect the pump stripper 7 at the side of the optical fiber fan-in 5 with respect to the multicore EDF 6 in the optical amplifier 100. Moreover, when power of pumping light that is output from the multicore EDF 6 and that has not contributed to optical amplifying is relatively low, it is not always needed to provide the pump stripper 7.

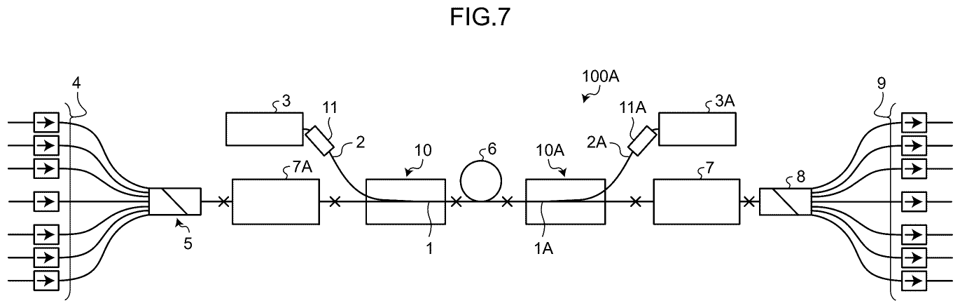

FIG. 7 is a schematic configuration diagram of an optical amplifier according to a first modification of the fourth embodiment. An optical amplifier 100A includes an optical coupler 10A, a pumping light source 3A, a pump stripper 7A, and pumping light blocking units 11 and 11A, in addition to the components of the optical amplifier 100 according to the fourth embodiment as illustrated in FIG. 5.

In the optical amplifier 100A, the pumping light source 3 is one example of a second pumping light source between two pumping light sources. As described above, the pumping light that is output from the pumping light source 3 propagates through the multicore EDF 6 in the same direction as signal light, and therefore, the pumping light source 3 performs forward pumping on the multicore EDF 6.

The optical coupler 10A is arranged between the multicore EDF 6 and the pump stripper 7. The optical coupler 10A has the same configuration as the optical coupler 10. In other words, the optical coupler 10A includes the multicore fiber 1A and an optical coupling optical fiber 2A. The multicore fiber 1A has the same configuration as the multicore fiber 1. The optical coupling optical fiber 2A has the same configuration as the optical coupling optical fiber 2.

The pumping light source 3A is, for example, a transverse multimode semiconductor laser and outputs pumping light. A wavelength of the pumping light is set to a wavelength included in a wavelength bandwidth of equal to or larger than 1450 nm and equal to or smaller than 1520 nm (second wavelength bandwidth) that is one example of a pumping bandwidth of erbium ion. Therefore, the pumping light optically excites erbium ion. The optical coupling optical fiber 2A transmits the pumping light output from the pumping light source 3A in a multimode. The pumping light is coupled with an inner cladding portion of the multicore fiber 1A in the optical coupler 10A, propagates through the inner cladding portion, and is input to the inner cladding portion 6b of the multicore EDF 6.

The pumping light that is output from the pumping light source 3A propagates through the multicore EDF 6 in an opposite direction of the signal light, and therefore, the pumping light source 3A performs backward pumping on the multicore EDF 6. In other words, the pumping light source 3A is one example of a first pumping light source between the two pumping light sources, and the optical coupler 10A and the pumping light source 3A are configured such that the pumping light source 3 performs backward pumping on the multicore EDF 6.

Meanwhile, each beam of signal light that is optically amplified by the multicore EDF 6 propagates through each of the core portions of the multicore fiber 1A of the optical coupler 10A, and is output to the pump stripper 7.

The pump stripper 7A is arranged between the optical fiber fan-in 5 and the optical coupler 10. The pump stripper 7A is a well-known device that transmits each beam of the signal light that is output from the optical fiber fan-in 5 and eliminates residual pumping light that is output from the multicore EDF 6 and that is caused by the pumping light coming from the pumping light source 3A. The pump stripper 7A may have the same configuration as the pump stripper 7.

In the present embodiment, the pumping light blocking unit 11 is arranged in the middle of the optical coupling optical fiber 2. The pumping light blocking unit 11 has a function to, when a part of the residual pumping light that is caused by the pumping light coming from the pumping light source 3A propagates through the optical coupling optical fiber 2, block the part of the residual pumping light before the part of the residual pumping light enters the pumping light source 3. The pumping light blocking unit 11 is an optical element, such as a bandpass filter or a wavelength coupler, that transmits the pumping light output from the pumping light source 3 and blocks the pumping light output from the pumping light source 3A. Further, it may be possible to arrange a filter, instead of the pumping light blocking unit 11, on an output facet of a semiconductor chip of the pumping light source 3, and use the filter as the pumping light blocking unit.

In the present embodiment, the pumping light blocking unit 11A is arranged in the middle of the optical coupling optical fiber 2A. The pumping light blocking unit 11A has a function to, when a part of the residual pumping light that is caused by the pumping light coming from the pumping light source 3 propagates through the optical coupling optical fiber 2A, block the part of the residual pumping light before the part of the residual pumping light enters the pumping light source 3A. The pumping light blocking unit 11A is an optical element, such as a bandpass filter or a wavelength coupler, that transmits the pumping light output from the pumping light source 3A and blocks the pumping light output from the pumping light source 3. Further, it may be possible to arrange a filter, instead of the pumping light blocking unit 11A, on an output facet of a semiconductor chip of the pumping light source 3A, and use the filter as the pumping light blocking unit.

In the optical amplifier 100A that is configured as described above, forward pumping is performed on the multicore EDF 6 by the pumping light in the first wavelength bandwidth (equal to or larger than 970 nm and equal to or smaller than 990 nm), and backward pumping is performed on the multicore EDF 6 by the pumping light in the second wavelength bandwidth (equal to or larger than 1450 nm and equal to or smaller than 1520 nm), so that it is possible to realize low-noise characteristics and high saturation output characteristics, in addition to the effects achieved by the optical amplifier 100.

Here, the inventors have compared optical amplifying characteristics obtained by the optical amplifier 100A and optical amplifying characteristics obtained by an optical amplifier according to a comparative embodiment. The optical amplifier according to the comparative embodiment is an optical amplifier in which the optical couplers 10 and 10A in the optical amplifier 100A are replaced with optical couplers that include outer cladding portions made of resin instead of the outer cladding portions made of glass. The resin is resin that is normally used in an optical fiber of a double-clad type. As a result, it is confirmed that optical amplification gain that is obtained by the optical amplifier 100A is higher than optical amplification gain that is obtained by the optical amplifier according to the comparative embodiment in the same operating condition. In this manner, a configuration using the optical couplers 10 and 10A as in the optical amplifier 100A is suitable for optical pumping in the second wavelength bandwidth.

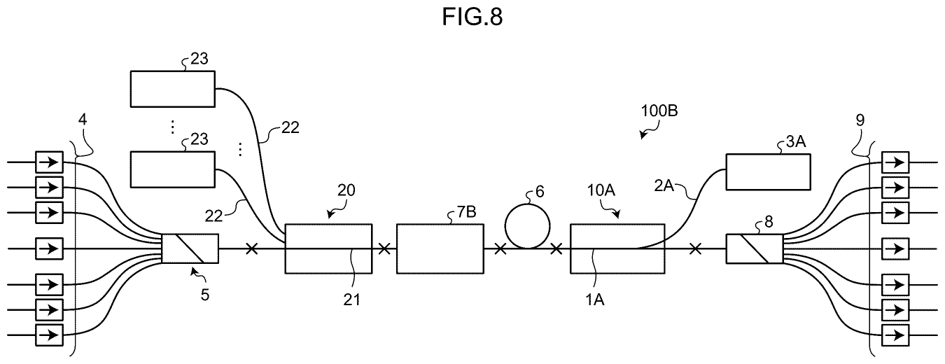

FIG. 8 is a schematic configuration diagram of an optical amplifier according to a second modification of the fourth embodiment. An optical amplifier 100B is configured such that, in the optical amplifier 100A according to the first modification as illustrated in FIG. 7, the optical coupler 10 and the pumping light source 3 are replaced with an optical coupler 20, a plurality of forward-pumping light sources 23, and a pump stripper 7B, and the pump strippers 7 and 7A and the pumping light blocking units 11 and 11A are removed.

The plurality of forward-pumping light sources 23 are, for example, transverse single-mode semiconductor lasers, and output forward-pumping light. A wavelength of the forward-pumping light is included in the first wavelength bandwidth that is equal to or larger than 970 nm and equal to or smaller than 990 nm. The number of the forward-pumping light sources 23 is 19 that is the same as the optical amplifying core portions 6a in the multicore EDF 6.

The optical coupler 20 includes a single-clad multicore fiber 21 and 19 optical coupling single-mode optical fibers 22. Each of the optical coupling single-mode optical fibers 22 is connected to each of the forward-pumping light sources 23, transmits forward-pumping light that is output by each of the forward-pumping light sources 23 in the single mode, and outputs the forward-pumping light to the single-clad multicore fiber 21. The single-clad multicore fiber 21 has the same configuration as the multicore fiber 1, but has a single-clad structure that does not include an outer cladding portion and includes only an inner cladding portion. Meanwhile, it may be possible to adopt the multicore fiber 1 including the outer cladding portion, instead of the single-clad multicore fiber 21.

Furthermore, a cutoff wavelength of each of the optical coupling single-mode optical fibers 22 and the 19 core portions included in the single-clad multicore fiber 21 is set so as to transmit the forward-pumping light in the single mode, and the cutoff wavelength is, for example, 970 nm.

The optical coupler 20 is configured to perform wavelength multiplexing or wavelength division multiplexing on each beam of signal light output from the optical fiber fan-in 5 and the forward-pumping light output from each of the optical coupling single-mode optical fibers 22, and outputs the multiplexed light to each of the core portions of the single-clad multicore fiber 21. In other words, the optical coupler 20 is configured as a core-pumped optical coupler. The optical coupler 20 as described above may include, for example, a plurality of well-known Wavelength Division Multiplexing (WDM) couplers for exciting a core.

The pump stripper 7B is arranged between the optical coupler 20 and the multicore EDF 6. The pump stripper 7B is, similarly to the pump stripper 7A, a well-known device that transmits each beam of the signal light that is output from the optical coupler 20 and eliminates residual pumping light that is output from the multicore EDF 6 and that is caused by pumping light coming from the pumping light source 3A. The pump stripper 7B may have the same configuration as the pump stripper 7A. However, in the present embodiment, a cutoff wavelength of each of the core portions in the pump stripper 7B is set so as to transmit forward-pumping light in the single mode.

The optical coupling single-mode optical fibers 22 and the pump stripper 7B as described above function as a guide unit that guides forward-pumping light that is output from each of the forward-pumping light sources 23 to each of the optical amplifying core portions 6a. As described above, the guide unit transmits the forward-pumping light in the single mode.

In the optical amplifier 100B configured as described above, the forward-pumping light with a wavelength that is included in the first wavelength bandwidth that is equal to or larger than 970 nm and equal to or smaller than 990 nm is input to the optical amplifying core portions 6a in the single mode. As a result, the optical amplifying core portions 6a are selectively excited in a single mode (fundamental mode); therefore, as compared to a case in which the optical amplifying core portions 6a are excited in a multimode, excited states of the optical amplifying core portions 6a become temporally stable, so that optical amplifying gain to be obtained become temporally stable.

Furthermore, in the optical amplifier 100B, each of the forward-pumping light sources 23 individually perform forward pumping on each of the optical amplifying core portions 6a, so that power of pumping light output from each of the forward-pumping light sources 23 is individually adjusted, and it is possible to reduce gain deviation among the optical amplifying core portions 6a.

Here, cutoff wavelengths of the optical amplifying core portions 6a may be set so as to transmit the forward-pumping light in the multimode when the optical amplifying core portions 6a transmit the signal light in the single mode. For example, when the wavelength of the signal light is equal to or larger than 1530 nm, it is sufficient to set the cutoff wavelengths of the optical amplifying core portions 6a to equal to or smaller than 1530 nm. Meanwhile, if the cutoff wavelengths of the optical amplifying core portions 6a are set so as to transmit the signal light in the single mode and transmit the forward-pumping light in the multimode, it is possible to increase core diameters of the optical amplifying core portions 6a. The optical amplifying core portions 6a having larger core diameters are able to more easily absorb cladding-pumping pumping light that is output from the pumping light source 3A. As a result, it is possible to easily increase amplifying optical power of the optical amplifier 100B.

Meanwhile, in the optical amplifier 100A according to the first modification as described above, it may be possible to remove the optical coupler 10, the pumping light source 3, and the pump stripper 7, and achieve a backward-pumping structure with pumping light in a second wavelength bandwidth that is equal to or larger than 1450 nm and equal to or smaller than 1520 nm. Furthermore, it may be possible to modify the configuration of the optical amplifier 100 according to the fourth embodiment and achieve a forward-pumping structure with pumping light in the second wavelength bandwidth.

According to one aspect of the present disclosure, it is possible to implement a multicore fiber that is able to reduce an influence of heat when an optical fiber is to be welded onto the multicore fiber, and implement an optical amplifier using the optical coupler.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A multicore fiber comprising:
a plurality of core portions each being made of glass;
an inner cladding portion made of glass with a lower refractive index than maximum refractive indices of the core portions and surrounding outer peripheries of the plurality of core portions; and
an outer cladding portion made of glass with a lower refractive index than the refractive index of the inner cladding portion and surrounding the inner cladding portion.

2. The multicore fiber according to claim 1, wherein the outer cladding portion is made of glass doped with fluorine.

3. The multicore fiber according to claim 1, further comprising:
a covering layer made of resin with a lower refractive index than the refractive index of the outer cladding portion and that surrounds the outer cladding portion.

4. The multicore fiber according to claim 1, wherein a softening point of the outer cladding portion is lower than a softening point of the inner cladding portion.

5. The multicore fiber according to claim 1, wherein a thickness of the outer cladding portion is equal to or larger than 10 micrometers.

6. The multicore fiber according to claim 1, wherein inter-core crosstalk between adjacent core portions among the plurality of core portions is equal to or smaller than −50 decibel per kilometer at a wavelength of light that is input to the core portions and propagates through the core portions.

7. The multicore fiber according to claim 1, wherein a distance between a central axis of a core portion that is located closest to an outer peripheral surface of the outer cladding portion among the plurality of core portions and the outer peripheral surface is equal to or larger than 20 micrometers.

8. The multicore fiber according to claim 1, wherein a numerical aperture that is determined by the refractive index of the inner cladding portion and the refractive index of the outer cladding portion is equal to or larger than 0.16 and equal to or smaller than 0.28 at a wavelength of light that is input to the inner cladding portion and that propagates through the inner cladding portion.

9. The multicore fiber according to claim 8, further comprising:
a covering layer made of resin with a refractive index equal to or larger than the refractive index of the outer cladding portion and that surrounds the outer cladding portion, wherein
a thickness of the outer cladding portion is equal to or larger than 10 times or more of a wavelength of light that is input to the inner cladding portion and that propagates through the inner cladding portion at the wavelength of the light.

10. An optical coupler comprising:
the multicore fiber according to claim 1; and
an optical coupling optical fiber that is welded onto the outer cladding portion of the multicore fiber and that transmits light to be coupled with the inner cladding portion of the multicore fiber.

11. The optical coupler according to claim 10, wherein coupling efficiency of the light transmitted by the optical coupling optical fiber with respect to the inner cladding portion is equal to or larger than 60%.

12. The optical coupler according to claim 10, wherein inter-core crosstalk between adjacent core portions among the plurality of core portions is equal to or smaller than −50 decibel at a wavelength of light that is input to the core portions of the multicore fiber and propagates through the core portions.

13. The optical coupler according to claim 10, wherein the optical coupling optical fiber is configured as a side-coupled optical coupler in which a portion in a longitudinal direction is welded along the outer cladding portion.

14. An optical amplifier comprising:
the optical coupler according to claim 10;
an optical amplifying multicore fiber including
a plurality of optical amplifying core portions made of glass and doped with an optical amplifying medium;
and an optical amplifying inner cladding portion made of glass with a lower refractive index than maximum refractive indices of the optical amplifying core portions and surrounding outer peripheries of the plurality of optical amplifying core portions; and
a pumping light source configured to input pumping light for optically exciting the optical amplifying medium to the optical coupling optical fiber of the optical coupler, wherein
each of the optical amplifying core portions of the optical amplifying multicore fiber is optically connected to each of the core portions of the multicore fiber of the optical coupler, and
the optical amplifying inner cladding portion of the optical amplifying multicore fiber is optically connected to the inner cladding portion of the multicore fiber of the optical coupler.

15. The optical amplifier according to claim 14, wherein
the optical amplifying medium is erbium, and
a wavelength of the pumping light is equal to or larger than 1450 nm and equal to or smaller than 1520 nm.

16. The optical amplifier according to claim 14, further comprising:
a plurality of forward-pumping light sources each being configured to output forward-pumping light that optically excites the optical amplifying medium and that has a wavelength equal to or larger than 970 nm and equal to or smaller than 990 nm; and
a guide unit configured to guide the forward-pumping light output from each of the forward-pumping light sources to each of the optical amplifying core portions, wherein
the optical amplifying medium is erbium,
the optical coupler and the pumping light source are configured to perform backward pumping on the optical amplifying multicore fiber, and
the guide unit is configured to transmit the forward-pumping light in a single mode.

17. The optical amplifier according to claim 14, further comprising:
the two optical couplers; and
the two pumping light sources, wherein
a wavelength of pumping light output from a first pumping light source between the two pumping light sources is equal to or larger than 1450 nm and equal to or smaller than 1520 nm,
a wavelength of pumping light output from a second pumping light source between the two pumping light sources is equal to or larger than 970 nm and equal to or smaller than 990 nm, and
the two optical couplers and the two pumping light sources are configured such that the first pumping light source performs backward pumping on the optical amplifying multicore fiber and the second pumping light source performs forward pumping on the optical amplifying multicore fiber.
